(19) United States
(12) Patent Application Publication
(10) Pub. No.: US 2021/0226250 A1
(43) Pub. Date: Jul. 22, 2021

(54) LITHIATED PERFLUORINATED POLYMER WITH MIXED LONG AND SHORT SIDE CHAINS AS A SINGLE- ION POLYMER ELECTROLYTE FOR LITHIUM METAL BATTERIES

(71) Applicant: FORD GLOBAL TECHNOLOGIES, LLC, Dearborn, MI (US)

(72) Inventor: Zijie LU, Novi, MI (US)

(21) Appl. No.: 16/745,662

(22) Filed: Jan. 17, 2020

(51) Int. Cl. H01M 10/0565; H01M 10/0525

(52) U.S. Cl. CPC H01M 10/0565; H01M 2300/0082; H01M 10/0525

(57) ABSTRACT

A polymer electrolyte includes an ionically conductive lithiated membrane including a single-ion polymer having a first lithiated perfluorosulfonic ionomer having a plurality of short side chains each including a short carbon chain of about 1 to 3 carbons, and a second lithiated perfluorosulfonic ionomer having a plurality long side chains each including a long carbon chain of about 4 to 7 carbons plasticized with the short side chains. The polymer electrolyte may further include a plasticizer.

### TECHNICAL FIELD

The present disclosure relates to a single-ion polymer electrolyte, and a method for producing the single-ion polymer electrolyte.

### BACKGROUND

Solid state batteries, which replace liquid electrolytes with solid state electrolytes (SSEs), have attracted enormous attention due to performance factors and higher energy density. SSEs include various groups, such as solid polymeric electrolytes and inorganic solid electrolytes. Within the groups, additional types of electrolytes exist, such as a single-ion polymer electrolyte (SIPE) within the group of polymeric electrolytes. SIPEs show improved performance in several factors, as well as manufacturing compatibility with current lithium ion battery technologies.

### SUMMARY

According to one or more embodiments, a polymer electrolyte includes an ionically conductive lithiated membrane including a single-ion polymer having a first lithiated perfluorosulfonic ionomer having a plurality of short side chains each including a short carbon chain of about 1 to 3 carbons, and a second lithiated perfluorosulfonic ionomer having a plurality long side chains each including a long carbon chain of about 4 to 7 carbons plasticized with the short side chains.

According to at least one embodiment, the first lithiated perfluorosulfonic ionomer may have an equivalent weight of 600 to 900 g/mol. In one or more embodiments, the second lithiated perfluorosulfonic ionomer may have an equivalent weight of at least 1000 g/mol. In at least one embodiment, the ionically conductive lithiated membrane may have a transference for lithium ions of about 0.80 to 1.00. In certain embodiments, the ionically conductive membrane may have an electrochemical stability of up to 5.0 V. In some embodiments, the short carbon chain may be 3 carbons. In other embodiments, the short carbon chain may be 2 carbons. In certain embodiments, the long carbon chain may be 4 to 5 carbons. In at least one embodiment, the polymer electrolyte may further include a plasticizer. The plasticizer may be PC, EC:PC, PEGDME, PEO, PEGMAₓ (where x is 100 to 50000), or a combination thereof. In some embodiments, the single-ion polymer may include 10 to 90 wt % of the first lithiated perfluorosulfonic ionomer, with a balance being the second lithiated perfluorosulfonic ionomer. In other embodiments, the single-ion polymer may include an 80:20 ratio by weight of the first and second lithiated perfluorosulfonic ionomers. In other embodiments, the single-ion polymer may include a 60:40 ratio by weight of the first and second lithiated perfluorosulfonic ionomers. In yet other embodiments, the single-ion polymer may include a 50:50 ratio by weight of the first and second lithiated perfluorosulfonic ionomers.

According to one or more embodiments, a method of forming a single-ion polymer electrolyte includes mixing a first perfluorosulfonic ionomer, of a single-ion polymer, having a plurality of short side chains, each including each a short carbon chain of about 1 to 3 carbons, with a second perfluorosulfonic ionomer, of the single-ion polymer, having a plurality of long side chains, each including a long carbon chain of about 4 to 7 carbons at a predefined ratio by weight, to form a mixture. The method further includes solution-casting the mixture to form a hydrogen-form electrolyte membrane, and lithiating the hydrogen-form electrolyte membrane to form an ionically conductive lithiated electrolyte membrane.

According to at least one embodiment, the method may further include immersing the lithiated electrolyte membrane in a 1:1 ratio by volume of ethylene carbonate and propylene carbonate. In one or more embodiments, the method may further include drying the lithiated electrolyte membrane under vacuum. In at least one embodiment, the first perfluorosulfonic ionomer may have an equivalent weight of 600 to 900 g/mol. In certain embodiments, the second perfluorosulfonic ionomer may have an equivalent weight of at least 1000 g/mol. In one or more embodiments, the predefined ratio may be 50:50 by weight.

According to one or more embodiments, a method of forming a polymer electrolyte membrane includes lithiating a 5 wt. % aqueous solution of a first perfluorosulfonic ionomer having a plurality of short side chains, each including each a short carbon chain of about 1 to 3 carbons by adding 1M LiOH to the solution until a pH of the mixture reaches 7.0 to form a first lithiated perfluorosulfonic ionomer, and lithiating a 5 wt. % aqueous solution of a second perfluorosulfonic ionomer having a plurality of long side chains, each including a long carbon chain of about 4 to 7 carbons by adding 1M LIOH to the solution until a pH of the mixture reaches 7.0 to form a second lithiated perfluorosulfonic ionomer. The method further includes drying the first and second lithiated perfluorosulfonic ionomers under a vacuum to form respective first and second lithiated perfluorosulfonic ionomer powders, and mixing the first and second lithiated perfluorosulfonic ionomer powders at 50:50 by weight to form a mixture. The mixture is dissolved in NMP solvent. The method is further includes adding a plasticizer to the mixture to form a polymer electrolyte solution; and casting the polymer electrolyte solution on film to dry and remove the NMP solvent and form the membrane.

### BRIEF DESCRIPTION OF THE DRAWINGS

FIG. 1 is a schematic showing lithiated perfluorinated polymer side chains with varying lengths;

FIGS. 2A and 2B show a schematic diagram and a schematic molecular view, respectively, of a single-ion polymer electrolyte membrane, according to an embodiment;

FIG. 3 is a table comparing properties of a conventional electrolyte and a single-ion polymer electrolyte according to an embodiment;

FIG. 4 is a graph showing cyclic voltammetry of the single-ion polymer electrolyte of FIG. 3;

FIG. 5 is a graph showing thermogravimetric analysis of the conventional electrolyte and single-ion polymer electrolyte of FIG. 3;

FIG. 6 is a graph showing the polarization of the single-ion polymer electrolyte of FIG. 3;

FIG. 7 is a table comparing properties of a conventional dual-ion conductor and a single-ion polymer electrolyte according to another embodiment; and

FIG. 8 is a graph showing thermogravimetric analysis of the conventional dual-ion conductor and single-ion polymer electrolyte of FIG. 7.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Moreover, except where otherwise expressly indicated, all numerical quantities in this disclosure are to be understood as modified by the word “about” in describing the broader scope of this disclosure. Practice within the numerical limits stated is generally preferred. Also, unless expressly stated to the contrary, the description of a group or class of materials by suitable or preferred for a given purpose in connection with the disclosure implies that mixtures of any two or more members of the group or class may be equally suitable or preferred. Furthermore, practice within the numerical limits stated is generally preferred.

Additionally, unless expressly stated to the contrary: all R groups (e.g. Rᵢ where i is an integer) include hydrogen, alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups; single letters (e.g., “n” or “o”) are 1, 2, 3, 4, or 5; in the compounds disclosed herein a CH bond can be substituted with alkyl, lower alkyl, C₁₋₆ alkyl, C₆₋₁₀ aryl, C₆₋₁₀ heteroaryl, —NO₂, —NH₂, —N(R′R″), —N(R′R″R′″)⁺L⁻, Cl, F, Br, —CF₃, —CCl₃, —CN, —SO₃H, —PO₃H₂, —COOH, —CO₂R′, —COR′, —CHO, —OH, —OR′, —O⁻M⁺, —SO₃⁻M⁺, —PO₃⁻M⁺, —COO⁻M⁺, —CF₂H, —CF₂R′, —CFH₂, and —CFR′R″ where R′, R″ and R′″ are C₁₋₁₀ alkyl or C₆₋₁₈ aryl groups; percent, “parts of,” and ratio values are by weight; the term “polymer” includes “oligomer,” “copolymer,” “terpolymer,” and the like; molecular weights provided for any polymers refers to weight average molecular weight unless otherwise indicated; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4, . . . 97, 98, 99, 100. Similarly, when any range is called for, intervening numbers that are increments of the difference between the upper limit and the lower limit divided by 10 can be taken as alternative upper or lower limits. For example, if the range is 1.1, to 2.1 the following numbers 1.2, 1.3, 1.4, 1.5, 1.6, 1.7, 1.8, 1.9, and 2.0 can be selected as lower or upper limits. In the specific examples set forth herein, concentrations, temperature, and reaction conditions (e.g. pressure, pH, etc.) can be practiced with plus or minus 50 percent of the values indicated rounded to three significant figures. In a refinement, concentrations, temperature, and reaction conditions (e.g., pressure, pH, etc.) can be practiced with plus or minus 30 percent of the values indicated rounded to three significant figures of the value provided in the examples. In another refinement, concentrations, temperature, and reaction conditions (e.g., pH, etc.) can be practiced with plus or minus 10 percent of the values indicated rounded to three significant figures of the value provided in the examples.

In the examples set forth herein, concentrations, temperature, and reaction conditions (e.g., pressure, pH, flow rates, etc.) can be practiced with plus or minus 50 percent of the values indicated rounded to or truncated to two significant figures of the value provided in the examples. In a refinement, concentrations, temperature, and reaction conditions (e.g., pressure, pH, flow rates, etc.) can be practiced with plus or minus 30 percent of the values indicated rounded to or truncated to two significant figures of the value provided in the examples. In another refinement, concentrations, temperature, and reaction conditions (e.g., pressure, pH, flow rates, etc.) can be practiced with plus or minus 10 percent of the values indicated rounded to or truncated to two significant figures of the value provided in the examples.

For all compounds expressed as an empirical chemical formula with a plurality of letters and numeric subscripts (e.g., CH₂O), values of the subscripts can be plus or minus 50 percent of the values indicated rounded to or truncated to two significant figures. For example, if CH₂O is indicated, a compound of formula C_{(0.8-1.2)}H_{(1.6-2.4)} O_{(0.8-1.2)}. In a refinement, values of the subscripts can be plus or minus 30 percent of the values indicated rounded to or truncated to two significant figures. In still another refinement, values of the subscripts can be plus or minus 20 percent of the values indicated rounded to or truncated to two significant figures.

The acid form of a the perfluorinate polymer, also interchangeably referred to as a perfluorosulfonic ionomer or PFSA (e.g., NAFION®, 1100 equivalent weight (EW)), is a polymer electrolyte membrane used in fuel cells. The PFSA can be lithiated to change the hydrogen form (H-form) of the ionomer to the lithium form (Li-form). After lithiation, the polymer electrolyte shows a significant improvement Li+ ion conductivity when compared with conventional electrolytes. Other advantages of a lithiated perfluorinated electrolyte include Li+ transference number unity, and improvements in mechanical strength, electrochemical stability, and thermal stability.

Various length of side chains of a lithiated perfluorinated ionomer are shown schematically in FIG. 1. Properties of a lithiated perfluorinated polymer electrolyte can be modified by adjusting the side chain structure, and more particularly, adjusting the side chain length. NAFION®, with 1100 EW, has a long side chain, i.e., of 4 to 6 carbons, however it displays a lower ionic conductivity when compared with short sider chain lithiated perfluorinated polymer electrolytes because of the chain length. A lithiated perfluorinated polymer electrolyte with a short side chain, i.e. containing fewer carbons, i.e., 2 to 4 carbons, has varied properties such as a higher ion concentration, which results in higher conductivity. Because of the lower equivalent weight of the lithiated perfluorinated polymer electrolyte with the short side chain, the ionic conductivity is improved when compared to the long side chain lithiated perfluorinated polymer electrolyte because the short side chain may lead to smaller size but larger number of ion clusters in the membrane. Although the short side chain lithiated perfluorinated polymer electrolyte shows certain improvements in ionic conductivity over the long side chain lithiated perfluorinated polymer electrolyte, short side chain ionomers, especially the ionomers with very low EW, are incapable of forming a free-standing membrane. Further, the membrane formed by low EW ionomers has limited strength.

According to one or more embodiments, a polymer electrolyte includes an ionically conductive lithiated membrane including a single-ion polymer having a short side chain lithiated perfluorinated ionomer mixed with a long chain lithiated perlluorinated ionomer. For example, the lithiated perfluorinated ionomer may be lithiated perfluorosulfonic acid (PFSA). The lithiated perfluorinated ionomer may be interchangeably referred to as lithiated perluosulfonic ionomer. The short side chains have a short carbon side chain of about 1 to 3 carbons, and the long carbon side chain has about 4 to 7 carbons, which form the single-ion polymer electrolyte via interaction with the short side chains. The single-ion polymer electrolyte is a free-standing membrane that is lithium ion conductive with a lithium ion transference number close to 1.0. In certain embodiments, the lithium transference number is greater than 0.8, in other embodiments, greater than 0.85, and in yet other embodiments, greater than 0.9. Moreover, the polymer electrolyte membrane is electrochemically stable up to 5.0 V vs Li/Li⁺. Additionally, the single-ion polymer electrolyte has low interfacial impedance with other battery materials, and has manufacturing compatibility with current LIB technologies.

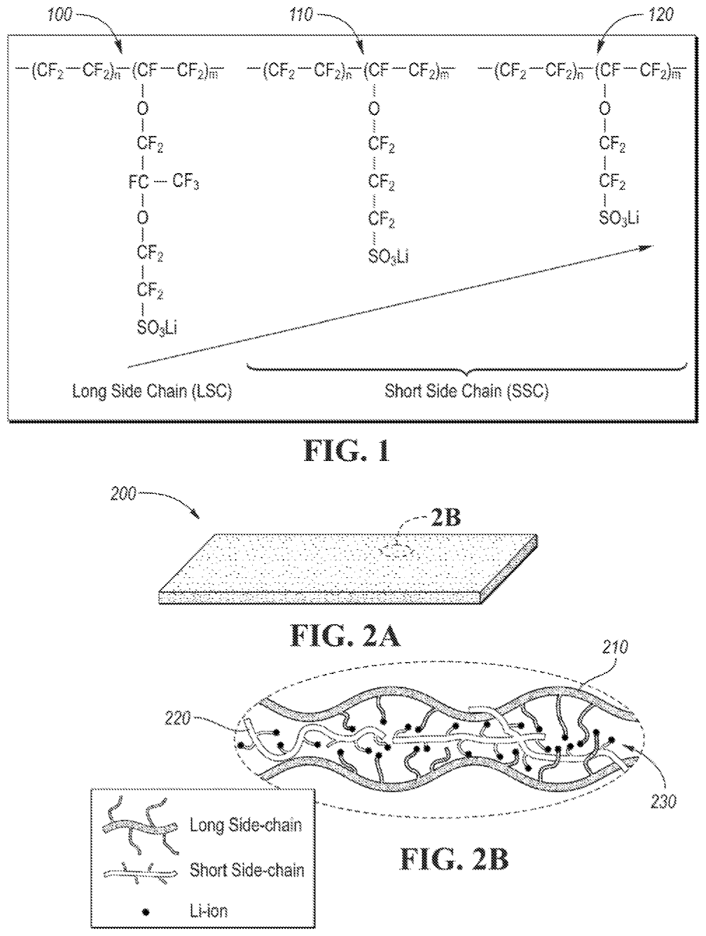

According to at least one embodiment, a solid state battery includes a positive electrode and a negative electrode, and a single-ion polymer electrolyte separator there between. The positive electrode may be a lithium metal electrode, graphite electrode, C—Si electrode, or other suitable electrode. The negative electrode may include a metal oxide (e.g., LiCoₓNi_{y}Mn_{1-x-y}O₂), LiFePO₄, sulfur, or other suitable electrode material. Referring to FIGS. 2A-B, the single-ion polymer electrolyte membrane 200 forms the separator and provides the ionic conduction needed for the separator. The single-ion polymer electrolyte membrane 200 may further be included as an ionic conductor and a binder in the solid-state anode and/or cathode. The single-ion polymer electrolyte membrane 200 includes a mixture of long side chain lithiated perfluorinated polymer 210 and short side chain lithiated perfluorinated polymer 220, having lithium ions 230 substituted for the hydrogen on the side chains. In some embodiments, the lithiated perfluorinated polymer is lithiated PFSA. The long side chain 210 has a carbon chain length of about 4 to 7 carbons in some embodiments, in other embodiments about 4 to 6 carbons, and in yet another embodiment about 4 to 5 carbons. The long side chain lithiated perfluorinated ionomer 210 may have an equivalent weight of at least 1000 g/mol in some embodiments, 1000 to 1500 g/mol in other embodiments, and 1000 to 1200 g/mol in yet other embodiments. The short side chain 220 has a carbon chain length of about 1 to 3 carbons in some embodiments, about 2 to 3 carbons in certain embodiments, 2 carbons in other embodiments, or 3 carbons in yet other embodiments. The short side chain lithiated perfluorinated ionomer 220 may have an equivalent weight of 600 to 900 g/mol in some embodiments, 650 to 850 g/mol in other embodiments, and 675 to 875 g/mol in yet other embodiments. Referring again to FIG. 1, an example of a lithiated long side chain lithiated perfluorinated ionomer 100 includes 4 carbons, an example of a short side chain lithiated perfluorinated ionomer 200 includes 3 carbons, and another example of a short side chain lithiated perfluorinated ionomer 300 includes 2 carbons. The mixture of short and long side chains provides a single-ion polymer electrolyte membrane 200 with improved properties. In the single-ion polymer electrolyte membrane, the long side chain and short side chain ionomers are present in about a 50:50 ratio by weight, in certain embodiments. In some other embodiments, the short side chain ionomers may be present as 10 to 90 wt %, in other embodiments, the short side chain ionomers may be present as 25 to 75 wt %, and in yet another embodiment, may be present as 40 to 60 wt %, the balance being the long side chain ionomer.

The single-ion polymer electrolyte also may include a plasticizer. The plasticizer may be a liquid (e.g., ethylene carbonate (EC), propylene carbonate (EC), poly(ethylene glycol) dimethyl ether (PEGDME) or a mixture of two or more former species) or non-liquid plasticizer (e.g., PEGMA950, poly(ethylene oxide) (PEO)). The single-ion polymer electrolyte including the mixture of long side chain and short side chain lithiated perfluorinated polymers has a higher ionic conductivity, electrochemical stability, cycle stability, and current density when compared to conventional electrolyte membranes containing only long side chain lithiated perfluorinated polymer.

According to one or more embodiments, a single-ion polymer electrolyte includes a lithiated perfluorinated ionomer having short side chains and a lithiated perfluorinated ionomer having long side chains. The short carbon chain length may be 1 to 3 carbons, and the long carbon chain length may be 4 to 7 carbons. The lithiated perfluorinated ionomer may be, in some embodiments, lithiated perfluorosulfonic acid (Li-PFSA). The single-ion polymer electrolyte is an ionically conductive membrane with a high conductivity for lithium ions. The perfluorinated backbone provides a membrane with high chemical and thermal stability. The electrolyte membrane does not require the addition of lithium salts because the cations (i.e., Li+ in Li-PFSA) can be easily dissociated from the tethered sulfonate groups with the assistance of the plasticizers. Since the anions are bound to the side chains of the polymer, the only mobile species are Li+ ions, resulting in a transference number close to 1.0. The noticeable properties of lithiated perfluorinated polymer electrolytes with mixed long and short side chains include, but are not limited to, a high Li+ transference number (tLi+ greater than 0.9); high ionic conductivity (greater than 0.1 mS/cm for electrolytes containing liquid plasticizers, and greater than 0.01 mS/cm for electrolytes containing non-liquid plasticizers at room temperature); and thermal stability.

### Experimental Results

### Example 1

In a first example, a single-ion polymer electrolyte membrane was prepared with a 50:50 ionomer percent mixture of 5 wt % long side chain H-form PFSA solution, having a carbon chain length of 6 carbons and an equivalent weight of 1100 g/mol, and 5 wt % short side chain H-form PFSA solution, having a carbon chain length of 2 carbons and an equivalent weight of 800 g/mol. The mixture is solution-casted to form an H-form membrane. The membrane was treated in 1M LiOH solution at 80° C. for 12 hours so each ionomer was converted to the Li-form PFSA. The Li-form membrane was then thoroughly rinsed in de-ionized water at 80° C. and dried under vacuum at 120° C. for 12 hours. The membrane then was soaked in a 1:1 ethylene carbonate and propylene carbonate (EC:PC) solution for one hour to obtain about 40 wt % of uptake of EC:PC solution. Higher EC:PC uptake is beneficial to giving even higher ionic conductivity, but it weakens the membrane mechanical strength. So for this preliminary study, the EC:PC uptake is limited to below 40 wt %, which provides relatively high ionic conductivity while maintains decent mechanical strength.

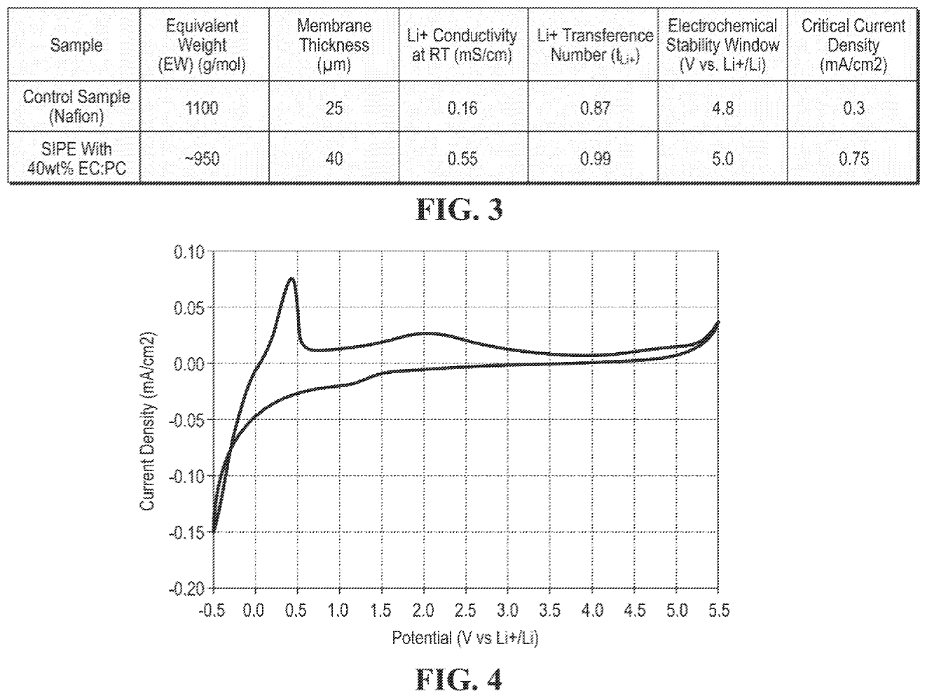

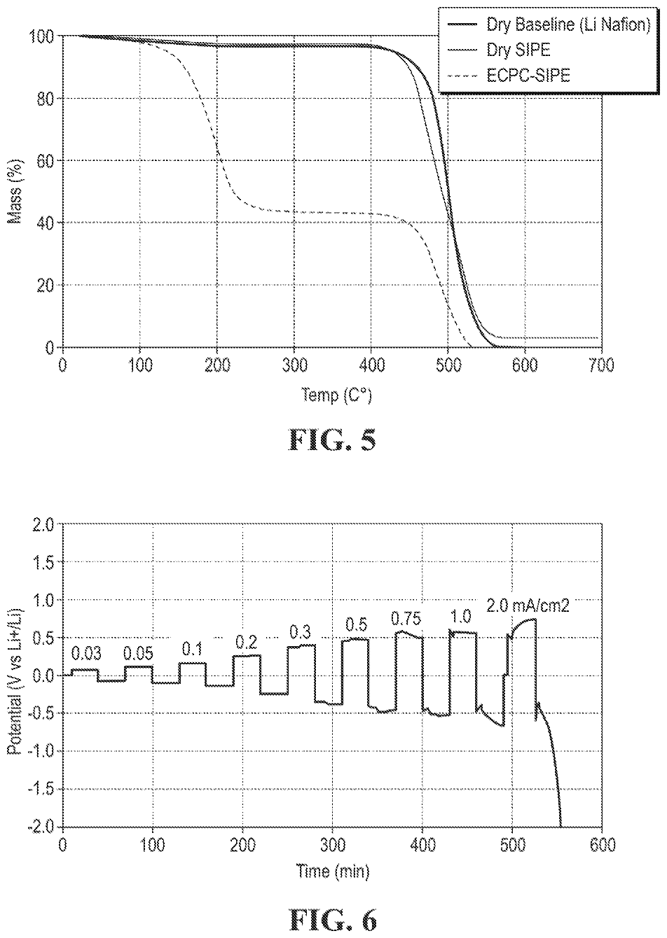

FIG. 3 shows the results of the single-ion polymer electrolyte of Example 1 when compared to the control sample of a conventional long side chain electrolyte (NAFION®). As can be seen in FIG. 3, the mixed single-ion polymer electrolyte has a lower EW, but shows a forms a thicker membrane with higher conductivity. Furthermore, the transference number for lithium is much higher, displaying the conductivity of the single ion. Furthermore, the voltage window is higher for the single-ion polymer electrolyte, as well as the critical current density. Thus, the membrane with the mixed short and long side chains shows an improvement in conductivity, transference number for lithium ions, and critical current density, which translates to improvement in performance of the cell. FIGS. 4-6 show various properties of the single-ion polymer electrolyte of Example 1, as compared with the long side chain electrolyte. FIG. 4 shows the cyclic voltammetry curve of the SS/EC:PC-SIPE membrane/Li cell between −0.5 and 5.5 V with a scan rate of 1 mV/s at room temperature. FIG. 5 shows the thermogravimetric analysis curves of the single-ion polymer electrolyte with EC:PC compared to that without EC:PC, along with the curve for the completely dried baseline SIPE. FIG. 6 shows the polarization plot of the Li/EC:PC-SIPE membrane/i cell at room temperature after 30-minute stripping-plating cycle with a stepwise increase of current density.

### Example 2

In another example, a 50:50 (by weight) single-ion polymer electrolyte solution was prepared. In the first step, the 5 wt % long side chain H-form PFSA and 5 wt % short side chain H-form PFSA aqueous solutions were converted to the respective Li-form solution by adding 1M LiOH dropwise until the pH values of the solutions reaching 7.0. The lithiated long-side chain and short-side chain solutions were completely dried under a vacuum at 120° C. for 12 hours and the powders of respective Li-PFSA were obtained. A mixture of two powders with a ratio of 50:50 (wt) was dissolved in NMP solvent at 80° C. and stirring to form the single-ion polymer electrolyte solution at desired concentration. The polymer electrolyte solution was then thoroughly mixed with selected solid plasticizers (PEGMA950 and EC+ PEGMA950) in desired compositions. The mixtures were casted on TEFLON® film and dried at 80° C. to remove the solvent NMP. The polymer electrolyte membrane was then peeled off the TEFLON® substrate and was evaluated. For the solid single-ion polymer electrolyte with plasticizers, the example was prepared with EC+PEGMA950, with ratios of EO:Li of 20:1 and EC:Li=3:1.

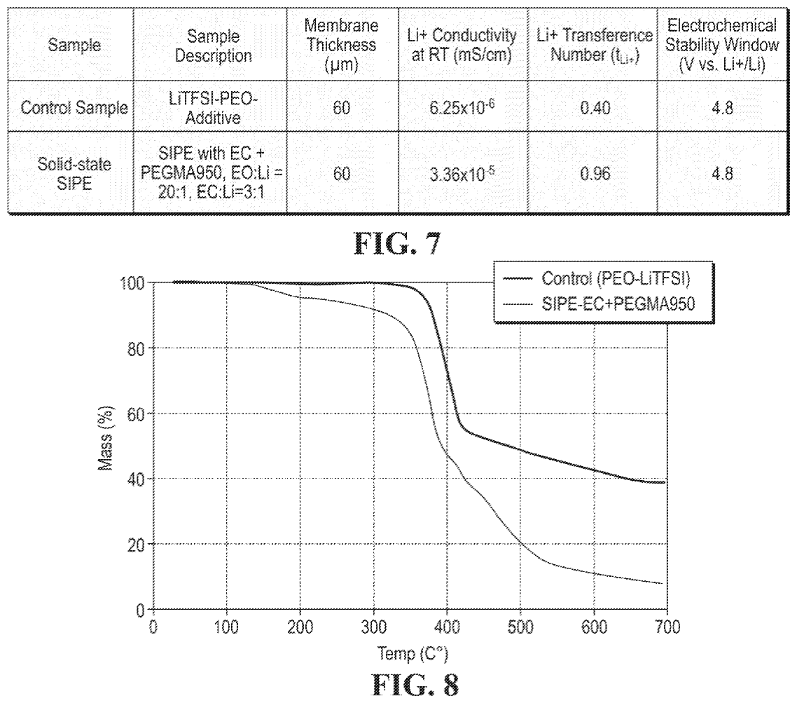

FIG. 7 shows the results of the single-ion polymer electrolyte of Example 2 (the solid single-ion polymer electrolyte with solid plasticizers) when compared to the control sample of LiTFSI-PEO-additive. As can be seen in FIG. 7, the single-ion polymer electrolyte has a similar membrane thickness, but a conductivity on a higher scale than the control. Similarly, the transference number is significantly higher than the control, with a similar electrochemical stability window for use in a cell. Thus, the membrane with the solid-state single-ion polymer electrolyte membrane shows an improvement in conductivity and transference number for lithium ions. FIG. 8 shows the thermogravimetric analysis curves of the solid-state single-ion polymer electrolyte with the plasticizer compared to the control.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A polymer electrolyte comprising:
an ionically conductive lithiated membrane including a single-ion polymer having
a first lithiated perfluorosulfonic ionomer having a plurality of short side chains each including a short carbon chain of about 1 to 3 carbons, and
a second lithiated perfluorosulfonic ionomer having a plurality long side chains each including a long carbon chain of about 4 to 7 carbons plasticized with the short side chains.

2. The polymer electrolyte of claim 1, wherein the first lithiated perfluorosulfonic ionomer has an equivalent weight of 600 to 900 g/mol.

3. The polymer electrolyte of claim 1, wherein the second lithiated perfluorosulfonic ionomer has an equivalent weight of at least 1000 g/mol.

4. The polymer electrolyte of claim 1, wherein the ionically conductive lithiated membrane has a transference for lithium ions of about 0.80 to 1.00.

5. The polymer electrolyte of claim 1, wherein the ionically conductive membrane has an electrochemical stability of up to 5.0 V.

6. The polymer electrolyte of claim 1, wherein the short carbon chain is 3 carbons.

7. The polymer electrolyte of claim 1, wherein the short carbon chain is 2 carbons.

8. The polymer electrolyte of claim 1, wherein the long carbon chain is 4 to 5 carbons.

9. The polymer electrolyte of claim 1, further comprising a plasticizer, wherein the plasticizer is PC, EC:PC, PEGDME, PEO, PEGMAx (x=100-50000), or a combination thereof.

10. The polymer electrolyte of claim 1, wherein the single-ion polymer includes 10 to 90 wt % of the first lithiated perfluorosulfonic ionomer, with a balance being the second lithiated perfluorosulfonic ionomer.

11. The polymer electrolyte of claim 1, wherein the single-ion polymer includes an 80:20 ratio by weight of the first and second lithiated perfluorosulfonic ionomers.

12. The polymer electrolyte of claim 1, wherein the single-ion polymer includes a 60:40 ratio by weight of the first and second lithiated perfluorosulfonic ionomers.

13. The polymer electrolyte of claim 1, wherein the single-ion polymer includes a 50:50 ratio by weight of the first and second lithiated perfluorosulfonic ionomers.

14. A method of forming a single-ion polymer electrolyte comprising:
mixing a first perfluorosulfonic ionomer, of a single-ion polymer, having a plurality of short side chains, each including each a short carbon chain of about 1 to 3 carbons, with a second perfluorosulofnic ionomer, of the single-ion polymer, having a plurality of long side chains, each including a long carbon chain of about 4 to 7 carbons at a predefined ratio by weight, to form a mixture;
solution-casting the mixture to form a hydrogen-form electrolyte membrane; and
lithiating the hydrogen-form electrolyte membrane to form an ionically conductive lithiated electrolyte membrane.

15. The method of claim 14, further comprising immersing the lithiated electrolyte membrane in a 1:1 ratio by volume of ethylene carbonate and propylene carbonate.

16. The method of claim 14, further comprising drying the lithiated electrolyte membrane under vacuum.

17. The method of claim 14, wherein the first perfluorosulfonic ionomer has an equivalent weight of 600 to 900 g/mol.

18. The method of claim 14, wherein the second perfluorosulfonic ionomer has an equivalent weight of at least 1000 g/mol.

19. The method of claim 14, wherein the predefined ratio is 50:50 by weight.

20. A method of forming a polymer electrolyte membrane comprising:
lithiating a 5 wt. % aqueous solution of a first perfluorosulfonic ionomer having a plurality of short side chains, each including each a short carbon chain of about 1 to 3 carbons by adding 1M LiOH to the solution until a pH of the mixture reaches 7.0 to form a first lithiated perfluorosulfonic ionomer;
lithiating a 5 wt. % aqueous solution of a second perfluorosulfonic ionomer having a plurality of long side chains, each including a long carbon chain of about 4 to 7 carbons by adding 1M LiOH to the solution until a pH of the mixture reaches 7.0 to form a second lithiated perfluorosulfonic ionomer;
drying the first and second lithiated perfluorosulfonic ionomers under a vacuum to form respective first and second lithiated perfluorosulfonic ionomer powders;
mixing the first and second lithiated perfluorosulfonic ionomer powders at 50:50 by weight to form a mixture;
dissolving the mixture in NMP solvent;
adding a plasticizer to the mixture to form a polymer electrolyte solution; and
casting the polymer electrolyte solution on film to dry and remove the NMP solvent and form the membrane.
